(19) United States
(12) Patent Application Publication
(10) Pub. No.: US 2008/0155052 A1
(43) Pub. Date: Jun. 26, 2008

(54) Method And System For Capture, Display And Network Analysis For A Wireless Access Point

(75) Inventor: Sridhar Ramesh, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS, INC., Dallas, TX (US)

(21) Appl. No.: 11/615,237

(22) Filed: Dec. 22, 2006

(51) Int. Cl. G06F 15/16

(52) U.S. Cl. 709/217

(57) ABSTRACT

A method is disclosed for capture, display, and analysis at a receiver-specific, per-packet level for a wireless access point. The method includes configuring an access point for a capture mode. In the capture mode, the access point captures information from a packet being processed through the access point's network stack, such as PHY or MAC layer information relevant to the access point. The method further includes encapsulating the captured information in an Ethernet packet, and tunneling the Ethernet packet with the captured information to a destination host computer. At the destination host computer, the Ethernet packet is decapsulated to obtain the captured information, which may then be displayed and/or analyzed according to well known methods.

### BACKGROUND

Packet capture and analysis tools are effective for studying and characterizing behavior of some network devices. For example, to analyze a Wireless Local Area Network (WLAN) card, the card may be installed on a Personal Computer (PC), and software executed by the PC, such as Pcap/WinPcap™, may be used to capture packets sent and received by the WLAN card. In turn, the packets are analyzed using an analysis tool, such as Ethereal. Such analysis provides insight into the behavior of the card in the network.

Such tools do not, however, capture and analyze receiver specific network information pertaining to access points in a WLAN.

### SUMMARY

Accordingly, disclosed herein is a method for capture, display, and analysis at a receiver-specific, per-packet level for a wireless access point. The method includes configuring an access point for a capture mode. In the capture mode, the access point captures information from a packet being processed through the access point's network stack, such as PHY or MAC layer information relevant to the access point. The method further includes encapsulating the captured information in an Ethernet packet, and tunneling the Ethernet packet with the captured information to a destination host PC. At the destination host PC, the Ethernet packet is decapsulated to obtain the captured information, which may then be displayed and/or analyzed according to well known methods.

Also disclosed is a system for capture, display, and analysis at a receiver-specific, per-packet level for a wireless access point. The system includes an access point wirelessly configured to receive packets from and send packets to a remote client, and a destination host PC coupled to an Ethernet port of the access point. The access point includes at least one Ethernet port, a processor, and a memory storing a software module that, when executed by the processor, causes the processor to capture information from a packet being processed through a network stack of the access point when the access point is in a capture mode, encapsulate the captured information in an Ethernet packet, and tunnel the Ethernet packet with the captured information to the destination host PC. The destination host PC has a destination MAC address, which routes tunneled ethernet packets from the access point.

Also disclosed herein is an access point device operable for capture, display, and analysis at a receiver-specific, per-packet level. The access point device includes at least one Ethernet port, a processor, and a memory storing a software module that, when executed by the processor, causes the processor to capture information from a packet being processed through a network stack of the access point when the access point is in a capture mode, encapsulate the captured information in an Ethernet packet, and tunnel the Ethernet packet with the captured information to a destination host PC coupled to the access point device at the Ethernet port.

### BRIEF DESCRIPTION OF THE DRAWINGS

For a detailed description of exemplary embodiments of the invention, reference will now be made to the accompanying drawings in which:

FIG. 1A shows a block diagram of a block diagram of a Local Area Network (LAN) in accordance with one or more embodiments.

FIG. 1B shows a block diagram of an access point of FIG. 1A in accordance with one or more embodiments.

FIG. 2A shows a block diagram of a data signal being processed through a network stack of a wireless access point in a normal receive mode in accordance with one or more embodiments.

FIG. 2B shows a block diagram of a data signal being processed through a network stack of a wireless access point in a capture mode in accordance with one or more embodiments.

FIG. 3 shows a block diagram of a data signal with receiver specific information captured from packets at a wireless access point, and tunneled to a destination host PC for display and analysis in accordance with one or more embodiments.

FIG. 4 shows a flowchart of a method for capture, display and network analysis for a wireless access point in accordance with one or more embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more parts and may be used to refer to a computer system or a portion of a computer system.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

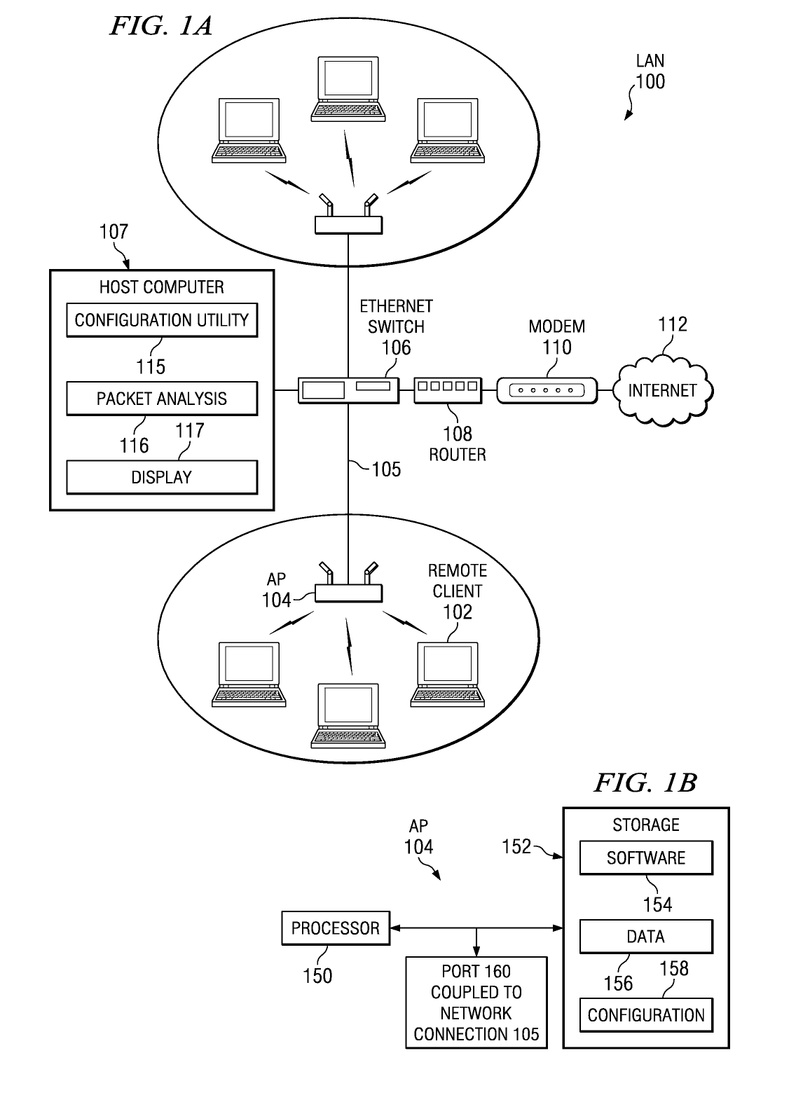

A block diagram of an illustrative Local Area Network (“LAN”) 100 is shown in FIG. 1A. One frequently used type of wireless LAN is the type in which a wireless enabled client 102 connects to an access point 104 in order to connect to the Internet 112. Wireless clients such as 102 can be mobile devices such as laptops, personal digital assistants (PDAs), Internet Protocol (IP) telephones or fixed devices such as desktops and workstations that are equipped with a wireless network interface card.

Access points, such as 104, are base stations, i.e., two-way transceivers that broadcast data into the surrounding environment, for the wireless network 100. Access point 104 couples via a wired network connection 105 to one or more network devices (e.g., switch 106) and also transmits to and receives radio frequencies from wireless enabled devices (such as wireless enabled device 102), thereby acting as a mediator between wired and wireless portions of the network 100. Access point 104 may be a hub or router that has an antenna built in to transmit and receive radio frequency communications. The access point 104 bridges wireless devices to wired portions of the network, i.e., an ethernet switch 106, coupling to a router 108 and modem 110 (Data Service Unit/Channel Service Unit or “DSU/CSU,” cable modem, DSL modem, or the like) thereby providing the connection to the Internet 112.

Packets received by the access point 104 cannot be analyzed or displayed at the access point 104. Some access points include a debug utility, but debug utilities typically have limited capability and are not used for per-packet analysis. Thus, there is a need for a scheme to capture receiver-specific information on a per-packet basis at the access point 104, and forward the receiver-specific information for display and analysis. Disclosed here is a method for capturing receiver specific information from a wireless access point, and forwarding the receiver-specific information to a host computer 107 connected via, for example, an Ethernet connection for display and/or analysis.

The disclosed method may be implemented in hardware already present in the access point and firmware executed by the access point 104 and/or hardware and firmware executed by a computer coupled to the access point 104 by an ethernet connection. When a similar or identical chipset to the chipset of WLAN cards is used in an access point (such as in wireless points offered commercially, for example, by Texas Instruments as TNETW1350A or TNETW1450), the hardware operable to carry out the methods disclosed here is present in the access point. The access point firmware in accordance with the present disclosure supports configuring the hardware for capture of information from the received packets. The access point 104 may be configured to pass Media Access Control (“MAC”), such as for example, Frame Check Sequence (“FCS”) information, or Physical Layer (“PHY”) (e.g., rate) information specific to the link layer (e.g., Ethernet). Such configuration may be performed, for example, using a web-based access point configuration utility.

The host computer 107 may host a configuration utility 115 that remotely configures the wireless access point 104 for either a normal receive mode, in which information specific to the access point is not captured, or a capture mode, in which information specific to the access point is captured and tunneled to the host computer. The host computer 107 may additionally host packet analysis software 116, such as Ethereal, which, when used with dissectors modified to de-capsulate the received Ethernet packets, may be used to retrieve the access point specific information contained in a packet for analysis and/or display. The host computer 107 may also include a display 117 on which information from the access point 104 may be viewed and analyzed.

Referring now to FIG. 1B, an embodiment of access point 104 is shown as comprising a processor 150 coupled to storage 152 and a port 160 that couples to the wired network connection 105. The storage 152 comprises a computer-readable medium such as volatile memory such as random access memory (RAM), non-volatile storage (e.g., hard disk, compact disc read only memory (CD ROM), read only memory (ROM), etc.) and combinations thereof. The port 160 coupled to the wired network connection 105 enables the access point 104 to communicate with the ethernet switch 106 and the host computer 107, among other network components.

The storage 152 of the access point 104 contains software 154 that is adapted to be executed by processor 150. The software 154, when executed by the processor 150, causes the processor 150 to perform various actions described herein that give the access point 104 some or all of its functionality. The access point's storage 152 also contains data 156 and the configuration 158 (i.e., as either normal receive mode or capture mode) that is used by the software 154 to perform various tasks.

A sending application (not shown) of the wireless enabled client 102 stores a sequence number and other data in a header in each packet sent to the access point 104. A network layer (i.e., an upper layer, not shown) of the wireless enabled client 102 adds source and destination data in the header, and a data link layer (i.e., Media Access Control “MAC” layer, not shown) of the wireless enabled client 102 adds station data in the header.

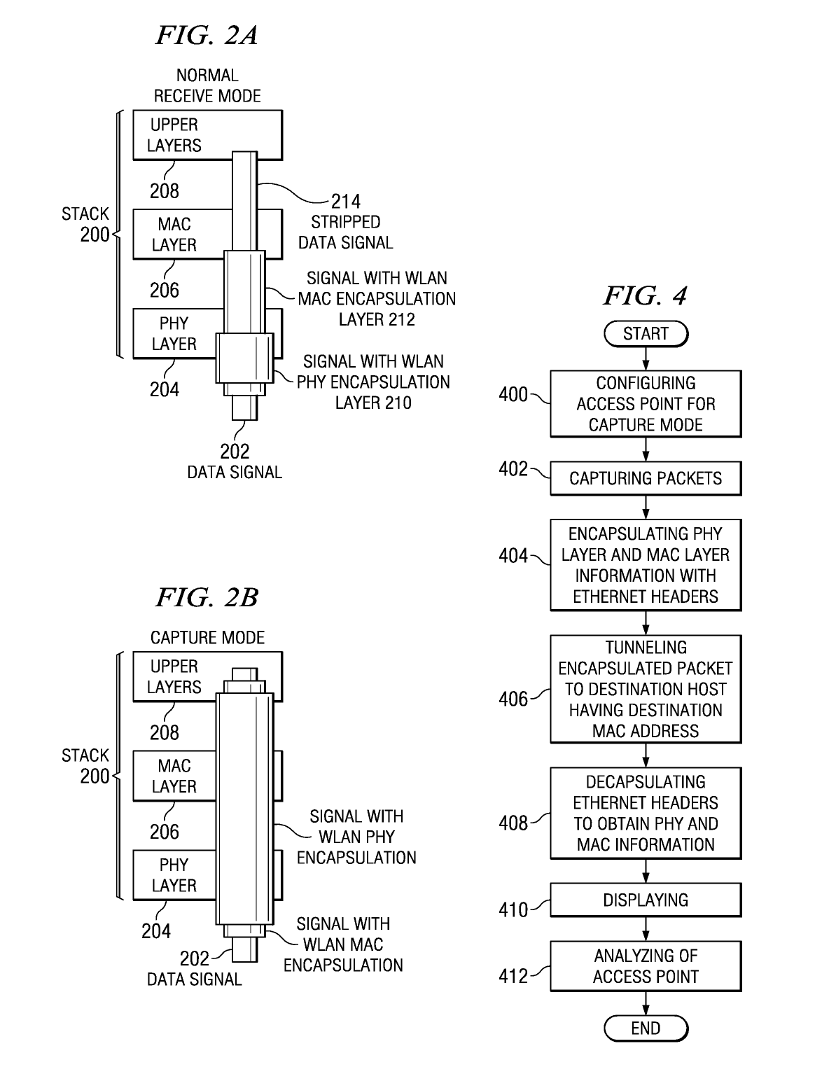

FIG. 2A shows a block diagram of a wireless data signal 202 being processed through a network stack 200 of a wireless access point 104 in a normal receive mode. When the access point 104 is in a normal receive mode, the packets, as packaged at the wireless enabled client 102, are received and processed by the network stack 200. The various network stack layers(204-208) of the access point 104 read and process the packets, and so processing, consume portions of the data signal (i.e., the packet). Specifically, as the headers, station data, and source and destination data are utilized by the network stack layers (204-208) in the access point in normal receive mode, such information is stripped off, used, and discarded. As shown in FIG. 2A, the data signal 202 received by the access point 104 at the physical layer 204 is layered to include a WLAN PHY encapsulation layer 210. The WLAN PHY encapsulation layer 210 may include, for example, encoding information. In the normal receive mode, the physical layer 204 strips, uses, and discards the WLAN PHY encapsulation layer 210. The data signal 202, stripped of the WLAN PHY encapsulation layer 210, proceeds to processing by the MAC layer 206.

With the WLAN PHYS encapsulation layer 210 stripped away, the next layer of the data signal 202 is the WLAN MAC encapsulation layer 212. The WLAN MAC encapsulation layer 212 may include, for example, the source and destination MAC address information. In the normal mode, the MAC layer 206 strips, uses, and discards the WLAN MAC encapsulation layer 212. The data signal 202, stripped of the WLAN MAC encapsulation layer 212, proceeds to processing by the Upper Layers 208, where the stripped data signal 214 (i.e., the data signal 202 less the WLAN PHY encapsulation layer 210 and the WLAN MAC encapsulation layer 212) is used. In various embodiments, the Upper Layers 208 may include, for example, the transport layer, the session layer, the presentation layer, and the application layer in the Open System Interconnection (“OSI”) protocol stack.

By contrast, FIG. 2B shows a block diagram of a data signal 202 being processed through a network stack 200 of a wireless access point in a capture mode. Specifically, as the headers, station data, and source and destination data are utilized by the network stack layers (204-208) in the access point in capture mode, such information is captured and encapsulated, instead of discarded. As shown in FIG. 2B, the data signal 202 coming into the physical layer 204 is layered to include a WLAN PHY encapsulation layer 210 and a WLAN MAC encapsulation layer 212. The WLAN PHY encapsulation layer 210 may include, for example, encoding information. In the capture mode, when the physical layer 204 processes the packet, rather than stripping and discarding the WLAN PHY encapsulation layer 210, the information from the WLAN PHY encapsulation layer 210 is captured. The data signal 202, including the information of the WLAN PHY encapsulation layer 210, proceeds to processing by the MAC layer 206.

The next layer of the network stack encountered by the data signal 202 is the MAC layer 206, which uses the WLAN MAC encapsulation layer 212. The WLAN MAC encapsulation layer 212 may include, for example, the source and destination MAC address information. In the capture mode, the MAC layer 206, instead of stripping off and discarding the WLAN MAC encapsulation layer 212, captures and encapsulates the information of WLAN MAC encapsulation layer 212. The data signal 202 then proceeds to processing by the Upper Layers 208, where the entire data signal 202 (i.e., the data signal 202 including the WLAN PHY encapsulation layer 210 and the WLAN MAC encapsulation layer 212) is used.

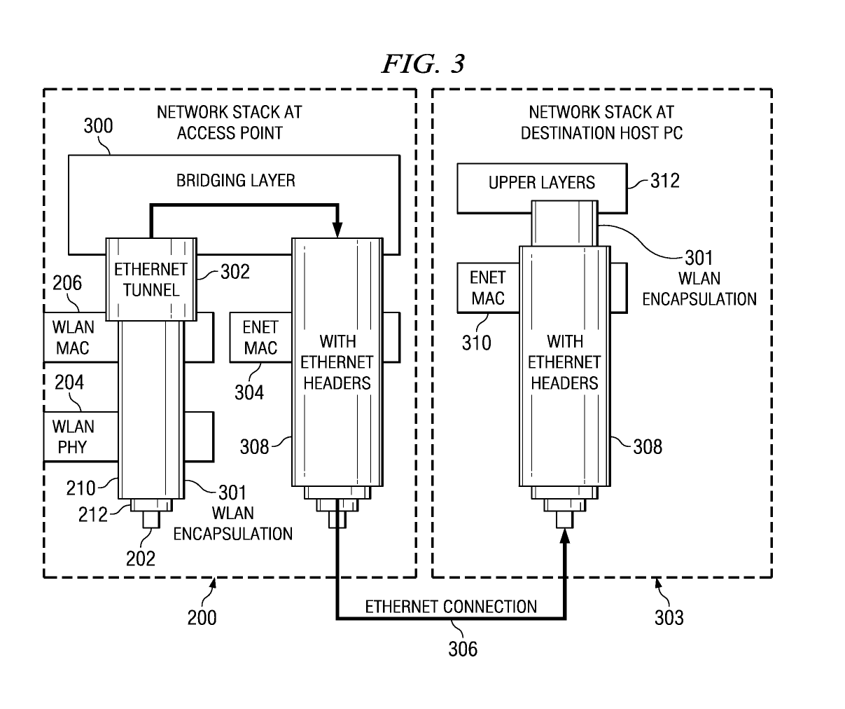

Captured packet information may be encapsulated into an Ethernet packet, and tunneled over Ethernet to a general purpose computer (“PC”) connected to the access point's Ethernet port. FIG. 3 shows a block diagram of the evoluation of a data signal with receiver-specific information captured from packets at a wireless access point, and tunneled to a network stack of a destination host PC 107 for display and analysis. The data signal 202 is processed by the network stack at the AP 200 (i.e., the WLAN PHY layer 204 and the WLAN MAC layer 206, each of which during capture mode do not strip off the WLAN headers that comprise the WLAN PHY encapsulation layer 210 and the WLAN MAC encapsulation layer 212). The data signal 202 with the WLAN PHY encapsulation layer 210 and the WLAN MAC encapsulation layer 212 together collectively comprise the WLAN encapsulation packet 301. The WLAN encapsulation packet is then prepared to be sent to the host PC 107 by way of the bridging layer 300 coupled to an ethernet MAC layer 304 and an ethernet connection 306. The WLAN encapsulation packet 301 reaches the bridging layer 300 by way of the Ethernet tunnel 302. The Ethernet connection 306 bridges between the ethernet MAC layer 304 of the access point network stack 200 and the ethernet MAC layer 310 of the host PC network stack 303. In normal receive mode, the access point network stack 200 layers strip off WLAN headers and tacks on Ethernet headers, but in capture mode, the network stack layers instead retain the WLAN headers and add Ethernet headers. Specifically, the bridging layer 300 in capture mode is the network stack layer that encapsulates the WLAN headers in an Ethernet packet, adding Ethernet headers to direct the encapsulated packet 301 to a destination host PC 107 according to the MAC address of the destination host PC 107. The WLAN packet with the Ethernet headers 308, shown in FIG. 3, is passed from the access point network stack 200 to the destination host PC network stack 303.

It is well known in the art to configure access points for communication using a web-based configuration utility program. A web-based configuration utility in accordance with the present disclosure provides, in addition to features typically available in a configuration utility program, the feature of enabling a change from normal receive mode to capture mode and vice versa. During configuration of the access point for capture mode, a destination MAC address may be specified using the access point configuration utility for the access point, for example. The destination MAC address may be multicast or unicast, and preferably does not coincide with that of any device on the same LAN 100. The bridging layer 300 adds the specified destination MAC address to the encapsulated packet as an Ethernet header, and passes the encapsulated packet to the Ethernet MAC layer 304 that links the access point 104 by the Ethernet port to the destination host PC 107 by an Ethernet connection 306.

The Ethernet MAC layer 310 of the destination host PC 107 receives the encapsulated packet, including the WLAN receiver-specific information as well as the Ethernet header added at the bridging layer 300. The Ethernet MAC layer 310 strips off the Ethernet header added at the bridging layer 300 that directed the packet 308 to the destination host PC 107. With the Ethernet header stripped off, the packet 301 is restored to the same receiver-specific data signal 200 that started at the WLAN PHY layer 204 for analysis and/or display at the PC, once processed by the upper layers 312 and passed to the appropriate application(s) (not shown).

FIG. 4 shows a flowchart of a method for capture, display and network analysis for a wireless access point. The method begins with configuring the access point for capture mode (block 400). Configuration may be performed by selection of a “capture” mode in the access point configuration utility to change the access point from normal receive mode to capture mode. In various embodiments, the access point configuration utility is a web-based application for configuration of the access point. Configuration may further include designating the destination MAC address of the destination host PC 107.

The method proceeds with the access point capturing packets in the capture mode (block 402). Within the access point network stack, MAC and/or PHY layer specific information specific to the access point receiver is captured, instead of stripped off. The receiver-specific information so captured is then passed to the link layer. The PHY layer and MAC layer information is encapsulated as an Ethernet packet by adding Ethernet headers (block 404). Specifically, at the bridging layer the packet is encapsulated with the captured information, and Ethernet headers are added to direct the packet when the packet is tunneled to the destination host PC 107.

The method continues with tunneling, or forwarding, the encapsulated packet to the destination host PC 107 with the destination MAC address (block 406). Tunneling is carried out via the Ethernet connection to the destination host PC 107, connected via the access point's Ethernet port. At the destination host PC 107, the method proceeds with decapsulating the Ethernet headers to restore the data, and obtain the PHY and MAC information captured in block 402 (block 408). For network analysis purposes, the PHY and MAC information may then be displayed (block 410) in the display of the destination host PC 107 and/or analyzed (block 412) according to the same techniques used in analogous analysis of a WLAN card installed in a PC. Tools, such as Ethereal, may be used with dissectors modified to de-capsulate the received Ethernet packets, retrieve the WLAN packets within, and examine the tunneled WLAN packets. In order to analyze information captured on packets at the access point, the analysis tool in block 412 filters the packets with the same destination address specified in the access point configuration utility to remove the ethernet headers added by the bridging layer 300, thereby restoring the packet to the WLAN encapsulation 301 for analysis.

Inasmuch as the systems and methods described herein were developed in the context of a LAN, the description herein is based on a LAN computing environment. However, the discussion of the various systems and methods in relation to a LAN computing environment should not be construed as a limitation as to the applicability of the systems and methods described herein to only LAN computing environments. One of ordinary skill in the art will appreciate that these systems and methods may also be implemented in other wireless computing environments such as Personal Area Networks (“PANs”), Wide Area Networks (“WANs”), Metropolitan Area Networks (“MANs”), and other networks implementing wireless access points to link wireless enabled devices to wired network infrastructure.

The above discussion is meant to be illustrative of the principles and various embodiments of this disclosure. Numerous variations and modifications will become apparent to those skilled in the art once the above disclosure is fully appreciated. It is intended that the following claims be interpreted to embrace all such variations and modifications.

1. A method, comprising:
configuring an access point for a capture mode;
in the capture mode, capturing information from a wirelessly received packet being processed through a network stack of the access point;
encapsulating the captured information in a packet; and
tunneling the packet with the captured information to a destination host computer.

2. The method of claim 1, further comprising decapsulating the packet to obtain the captured information at the destination host computer.

3. The method of claim 1, wherein the captured information comprises at least one of 1) information used by a physical (PHY) layer of the network stack in the access point, and 2) information used by a Medium Access Control (MAC) layer of the network stack in the access point.

4. The method of claim 1, wherein encapsulating the captured information in an packet further comprises adding to the captured information an Ethernet header with destination MAC address, and wherein the destination MAC address is associated with the destination host computer.

5. The method of claim 2, wherein decapsulating the packet further comprises stripping off the Ethernet header such that the captured information remains.

6. The method of claim 1, further comprising re-configuring the access point for normal receive mode in which information is stripped from the packet.

7. The method of claim 1, wherein configuring the access point for the capture mode is performed using a web-based configuration utility program for the access point.

8. The method of claim 1, further comprising displaying the captured information on a display of the destination host computer.

9. The method of claim 1, further comprising analyzing the captured information using an application executed by the destination host computer, and thereby characterizing the access point.

10. A system, comprising:
an access point configured to wirelessly receive packets from a remote client and send packets to the remote client, wherein the access point comprises at least one port;
a destination host computer coupled to the port of the access point, wherein the destination host computer has a destination Media Access Control (“MAC”) address;
wherein the access point further comprises:
a processor;
a memory storing a software module that, when executed by the processor, causes the processor to:
in the capture mode, capture information from a packet being processed through a network stack of the access point;
encapsulate the captured information in a packet; and
tunnel the packet with the captured information to the destination host computer.

11. The system of claim 10, wherein the destination host computer decapsulates the packet to obtain the captured information, by stripping off the header such that the captured information remains.

12. The system of claim 10, wherein the captured information comprises at least one of 1) information used by a physical (PHY) layer of the network stack in the access point, and 2) information used by a Medium Access Control (MAC) layer of the network stack in the access point.

13. The system of claim 10, wherein encapsulating the captured information in an packet further causes the processor to add to the captured information an Ethernet header with destination MAC address; wherein the destination MAC address is associated with the destination host computer.

14. The system of claim 10, further comprising a web-based configuration utility program executing on at least one of 1) one of the remote clients coupled to the access point and 2) the destination host computer, wherein the configuration utility program is operable to configure the access point for the capture mode or a normal receive mode.

15. The system of claim 10, wherein the destination host computer further comprises a display that displays the captured information.

16. The system of claim 10, wherein the destination host computer further comprises an application operable to analyze the captured information, and thereby characterize the access point.

17. An access point device, comprising:
at least one port;
a processor;
a memory storing a software module that, when executed by the processor, causes the processor to:
in a capture mode, capture information from a packet being processed through a network stack of the access point;
encapsulate the captured information in a packet; and
tunnel the packet with the captured information to a destination host computer coupled to the access point device at the port.

18. The access point device of claim 17, wherein the captured information comprises at least one of 1) information used by a physical (PHY) layer of the network stack in the access point, and 2) information used by a Medium Access Control (MAC) layer of the network stack in the access point.

19. The access point device of claim 17, wherein encapsulating the captured information in a packet further causes the processor to add to the captured information an header with destination MAC address; wherein the destination MAC address is associated with the destination host computer.

20. The access point device of claim 17, wherein a remote computer executing a configuration utility program configures the access point device for the capture mode or a normal receive mode.
